(19) United States
(12) Patent Application Publication
(10) Pub. No.: US 2020/0298834 A1
(43) Pub. Date: Sep. 24, 2020

(54) Vehicle Control Device and Automatic Parking System

(71) Applicant: Hitachi Automotive Systems, Ltd., Hitachinaka-shi, Ibaraki (JP)

(72) Inventor: Hiroshi KISHIDA, Hitachinaka-shi (JP)

(21) Appl. No.: 16/646,900

(22) PCT Filed: Sep. 5, 2018
(86) PCT No.: PCT/JP2018/032807

§ 371 Date: Mar. 12, 2020

(30) Foreign Application Priority Data
Sep. 28, 2017 (JP) 2017-188286

(51) Int. Cl. B60W 30/06; B60W 30/09; B60W 10/18; B60W 60/00; B60W 50/04

(52) U.S. Cl. CPC B60W 30/06; B60W 30/09; B60W 10/18; B60W 2050/0077; B60W 60/0017; B60W 50/045; B60W 60/0016

(57) ABSTRACT

During automated valet parking, when a parking facility is not spacious it is impossible to avoid null-point positions. Therefore, this vehicle control device is equipped with: a wireless communication unit for acquiring, from a control center by means of wireless communication, a null point indicating a position at which wireless communication is poor in a parking facility, and instruction information for controlling a vehicle in the parking facility; and an automatic driving control unit for moving the vehicle until the vehicle has escaped a null point and then stopping the vehicle, when the instruction information acquired by the wireless communication unit is an instruction for stopping the vehicle and the instructed stopping position is a null point.

### TECHNICAL FIELD

The present invention relates to a vehicle control device and an automatic parking system.

### BACKGROUND ART

In recent years, vehicle control devices that automatically drive vehicles have been developed. As examples thereof, there are known inter-vehicle distance keeping travel control that maintains a constant inter-vehicle distance from a preceding vehicle that travels on the front side while recognizing the front of the vehicle and travel lane keeping control that performs travel control so as not to deviate from a travel lane of a vehicle, for example. Furthermore, as an advanced type thereof, studies have been conducted on automated valet parking that automatically parks a vehicle in a parking facility of a building by automatic driving without being operated by a passenger.

In the automated valet parking, instruction information, such as a vehicle entry/exit instruction with respect to the parking facility, a vehicle stop instruction, and a vehicle start instruction, is transmitted to the vehicle by means of wireless communication which is used for C2X (Car-to-X)/V2X (Vehicle-to-X) and the like as a mobile phone network and road-to-vehicle/vehicle-to-vehicle communication from a control center. The vehicle stops, starts, and performs parking in the parking facility by automatic driving according to the instruction information. For example, when the instruction information is parking of the vehicle, the vehicle travels to a designated parking position by automatic driving and is parked at the designated parking position.

In the wireless communication, however, a direct wave transmitted from the control center and an interference wave overlap with each other at a reception site to cancel each other so that a null point is generated. At this null point, the interference wave changes due to a change in an environment of a parked vehicle or the like, and the null-point position also changes due to this change. Further, it is difficult for the control center to perform transmission and reception with the vehicle by wireless communication at the null point. For example, when a stop instruction is received from the control center for a certain region before the vehicle is parked at the designated parking position, the vehicle during the automatic driving is stopped. At this time, if the vehicle stops at the null point, the wireless communication is not possible even if there is a start instruction from the control center, and thus, the vehicle fails to restart and stays there.

PTL 1 describes an in-vehicle computer that transmits null point position information to a vehicle in advance and performs automatic parking based on the position information and calculates a movement trajectory of the vehicle so as to avoid a null-point position.

### CITATION LIST

### Patent Literature

PTL 1: JP 2009-239744 A

### SUMMARY OF INVENTION

### Technical Problem

With the technique described in PTL 1, it is difficult to avoid the null-point position when a parking facility is not spacious.

### Solution to Problem

The vehicle control device according to the present invention includes: a wireless communication unit that acquires a null point indicating a position at which wireless communication is poor in a parking facility and instruction information for controlling a vehicle in the parking facility from a control center by means of wireless communication; and a control unit that moves the vehicle until the vehicle has escaped the null point and then stops the vehicle when the instruction information acquired by the wireless communication unit is an instruction for stopping the vehicle and an instructed stopping position is the null point.

An automatic parking system according to the present invention includes a vehicle control device and a control center that performs wireless communication with the vehicle control device.

### Advantageous Effects of Invention

According to the present invention, it is possible to prevent the vehicle from stopping at the null point even when the parking facility is not spacious.

### BRIEF DESCRIPTION OF DRAWINGS

FIG. 1 is a configuration diagram of a vehicle.

FIG. 2 is a configuration diagram of a control center.

FIG. 3 is a diagram illustrating a position of a vehicle in a parking facility.

FIG. 4 is a flowchart illustrating an operation of the vehicle.

FIG. 5 is a flowchart illustrating an operation of the vehicle when detecting an obstacle.

### DESCRIPTION OF EMBODIMENTS

Hereinafter, embodiments of the present invention will be described with reference to the drawings.

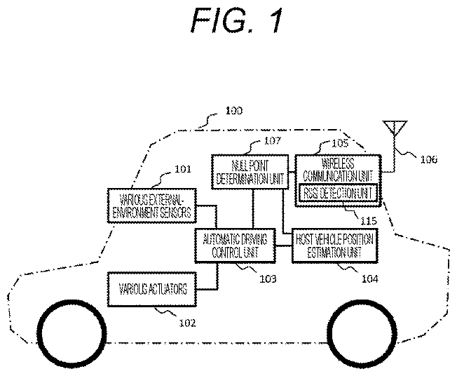

FIG. 1 is a configuration diagram of a vehicle 100. The vehicle 100 includes various external-environment sensors 101, various actuators 102, an automatic driving control unit 103, a host vehicle position estimation unit 104, a wireless communication unit 105, an antenna 106, and a null point determination unit 107.

The various external-environment sensors 101 include a camera, a millimeter wave radar, an infrared radar, and the like in order to detect an obstacle and the like and enable automatic driving of the vehicle 100.

The various actuators 102 include an engine that drives the vehicle, a brake that brakes the vehicle, and the like, and control the power of the vehicle 100.

The automatic driving control unit 103 controls the various actuators 102 based on information from the various external-environment sensors 101 and the like, and causes the vehicle 100 to enter or exit a parking facility by automatic driving.

The host vehicle position estimation unit 104 estimates a current position of the vehicle 100 from information such as a global positioning system (GPS), a Global Navigation Satellite System (GNSS), and a gyro sensor, and outputs the information on the current position to the automatic driving control unit 103 and the like.

The wireless communication unit 105 performs wireless communication with a control center 200, which will be described later, via the antenna 106, and receives instruction information such as stop, start, entry, and exit of the vehicle 100 from the control center 200, for example. Further, a detailed map of the parking facility and information indicating a null-point position are received from the control center 200. The wireless communication unit 105 transmits/receives information by means of wireless communication which is used for C2X (Car-to-X)/V2X (Vehicle-to-X) or the like as a mobile phone network or road-to-vehicle/vehicle-to-vehicle communication.

Further, the wireless communication unit 105 includes an RSSI detection unit 115. The RSSI detection unit 115 detects a reception signal intensity indicator (RSSI) of the wireless communication unit 105.

The null point determination unit 107 stores the null point received from the control center 200 via the wireless communication unit 105. The null point is position information represented by latitude, longitude, and the like. Further, the null point determination unit 107 acquires the current position of the vehicle 100 from the host vehicle position estimation unit 104. Then, the null point determination unit 107 acquires the reception signal intensity detected by the RSSI detection unit 115, and determines that the vehicle 100 has escaped the null point if the reception signal intensity exceeds a threshold along with the movement of the vehicle 100 from the null point. This determination result is output to the automatic driving control unit 103, and driving control of the vehicle 100 is performed according to the determination result. The reception signal intensity detected by the RSSI detection unit 115 is sequentially transmitted to the control center 200 via the wireless communication unit 105 together with the current position information acquired by the host vehicle position estimation unit 104.

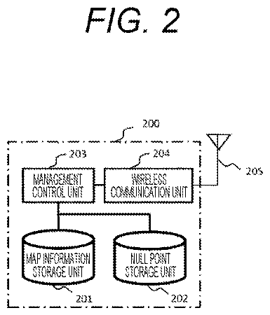

FIG. 2 is a configuration diagram of the control center 200. The control center 200 includes a map information storage unit 201, a null point storage unit 202, a management control unit 203, a wireless communication unit 204, and an antenna 205.

The map information storage unit 201 stores the detailed map of the parking facility. This detailed map also includes arrangement information of vehicles parked in the parking facility.

The null point storage unit 202 stores the null point of the parking facility. A direct wave and an interference wave of wireless communication are different depending on the arrangement of vehicles parked in the parking facility, and thus, the null point of the parking facility is also different. The null point storage unit 202 stores the null point of the parking facility in association with the arrangement information of vehicles parked in the parking facility. Then, when the vehicle 100 enters or exits, a null point corresponding to current arrangement information of vehicles parked in the parking facility is read out.

The management control unit 203 instructs entry, exit, stop, start, and the like to the vehicle 100 so as to achieve the consideration of safety and smooth operation in response to the arrangement of vehicles parked in the parking facility and the movement of other vehicles. Further, the management control unit 203 accumulates the reception signal intensity transmitted from the vehicle 100 and the position information thereof, and updates the null point corresponding to the vehicle arrangement information. Specifically, mapping is performed including a site where the reception signal intensity is equal to or greater than the threshold and a site where the reception signal intensity is less than the threshold so that information has not been transmitted, and the null-point position indicating the position where the wireless communication in the parking facility is poor is determined on the map. Then, the null point is stored in the null point storage unit 202 in association with the vehicle arrangement information.

The wireless communication unit 204 performs wireless communication with the vehicle 100 via the antenna 205, and transmits instruction information such as stop, start, entry, and exit from the control center 200 to the vehicle 100, for example. Further, the control center 200 transmits the detailed map of the parking facility and the information indicating the null-point position.

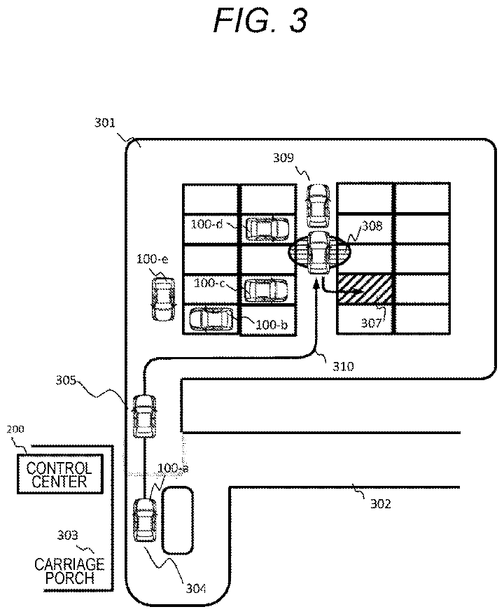

Next, the operation of the present embodiment will be described with reference to FIGS. 3 to 5.

FIG. 3 is a view illustrating vehicle positions in a parking facility 301, and illustrates an outline of vehicle parking using automated valet parking.

In the parking facility 301, the control center 200 is installed near a carriage porch 303, vehicles 100-b to 100-d are parked, and a vehicle 100-e is traveling. The vehicle 100-a is stopped near the carriage porch 303 and waits for the entry. Each of the vehicles 100-a to 100-e has the configuration illustrated in FIG. 1. Each of the vehicles 100-a to 100-e performs wireless communication with the control center 200, travels in the parking facility 301 by automatic driving, and is caused to enter or exit a parking spot by automated valet parking.

In the automated valet parking, a driver stops the vehicle 100-a at a stopping position 304 near the carriage porch 303 and gets off. If another passenger is present, the passenger also gets off in the same manner. The driver instructs the control center 200 to start the automated valet parking using a mobile phone or the like. This instruction may be made via a voice, or a command may be transmitted.

The control center 200 searches for a route 310 to a parking position 307 and instructs the vehicle 100-a to start. When encountering the other vehicle 100-e at a position 305 in the middle of the route 310, the vehicle 100-a receives a stop instruction from the control center 200. At this time, the vehicle 100-a determines whether or not the position 305 is a null point, and stops at the position 305 if it is not the null point. When it is determined as the null point, the vehicle 100-a moves to a position where the vehicle 100-a has escaped the null point as will be described later.

Thereafter, the vehicle 100-a further advances along the route 310 upon receiving a start instruction from the control center 200.

Further, it is assumed that a stop instruction is received from the control center 200 at a position 308 near the parking position 307. If the position 308 corresponds to the null point provided from the control center 200, the vehicle 100-a does not stop at the position 308, and the vehicle 100-a moves at the slowest speed. Further, if the reception signal intensity detected by the RSSI detection unit 115 of the vehicle 100-a is equal to or greater than the threshold, it is determined that the vehicle 100-a has escaped the null point, and the vehicle 100-a stops at the position 309. Thereafter, the vehicle 100-a is parked at the designated parking position 307 upon receiving a start instruction for parking.

When the vehicle 100-a is parked at the designated parking position 307, the RSSI detection unit 115 of the vehicle 100-a detects the reception signal intensity and confirms that the reception signal intensity is equal to or greater than the threshold. If the reception signal intensity is equal to or greater than the threshold, parking is completed at this position. When the reception signal intensity is less than the threshold, the vehicle 100-a moves to a position where the reception signal intensity is equal to or greater than the threshold, for example, a position 309, asks the control center 200 to change the parking position, and changes the parking position according to an instruction from the control center 200.

During the traveling along the route 310, the vehicle 100-a sequentially transmits the reception signal intensity detected by the RSSI detection unit 115 to the control center 200 by means of wireless communication together with the current position information. The management control unit 203 accumulates the reception signal intensity transmitted from the vehicle 100 and the position information thereof, and updates the null point corresponding to the vehicle arrangement information. This corresponds to the case where the null point changes depending on the arrangement of the other parked vehicles 100-b to 100-d. Thus, the database of the null point storage unit 202 of the control center 200 is updated, and the relationship between the vehicle arrangement information and the null point is learned to determine the null point.

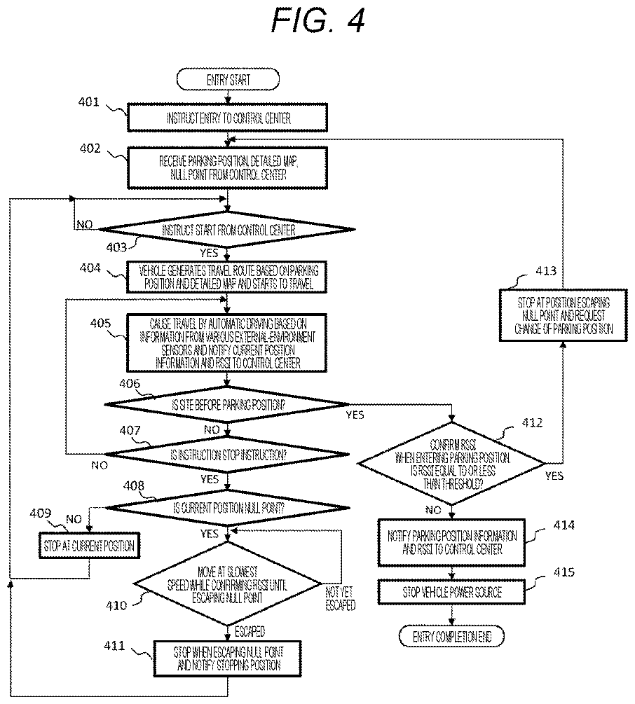

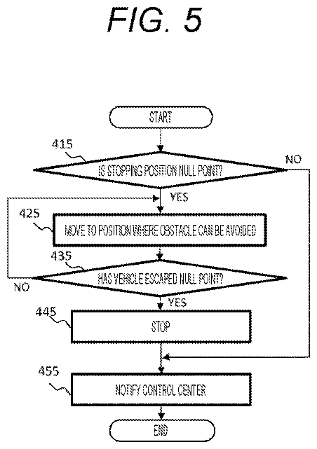

FIGS. 4 and 5 are flowcharts illustrating operations at the time of entry and exit of the vehicle 100. These flowcharts illustrate processing operations of the automatic driving control unit 103, the null point determination unit 107, and the like of the vehicle 100. Incidentally, programs illustrated in these flowcharts may be realized by execution using a computer that includes a CPU, a memory, and the like. Further, these programs may be supplied as various forms of computer-readable computer program products such as a recording medium and a data signal (carrier wave).

A driver and a passenger stop the vehicle 100 near the carriage porch 303 and get off. Then, in Step 401 of FIG. 4, the driver instructs the control center 200 to start automated valet parking using a mobile phone or the like.

In Step 402, the vehicle 100 receives a parking position, a detailed map of a parking facility, and a null point from the control center 200.

In Step 403, the vehicle 100 stands by until a start instruction is received from the control center 200. When the start instruction is received, the process proceeds to Step 404.

In Step 404, the vehicle 100 generates the travel route 310 based on the parking position and the detailed map of the parking facility, and starts traveling along the travel route 310.

In Step 405, the vehicle 100 controls the various actuators 102 based on information from the various external-environment sensors 101 and travels along the travel route 310 by automatic driving. Then, the current position information and the reception signal intensity (RSSI) are sequentially transmitted to the control center 200.

In Step 405, when the vehicle 100 detects an obstacle using the various external-environment sensors 101, a processing operation illustrated in FIG. 5, which will be described later, is performed.

In Step 406, it is determined whether the vehicle 100 has reached a site before the parking position. If the vehicle 100 has not reached the site before the parking position, it is determined in Step 407 whether the vehicle 100 has received a stop instruction from the control center 200. This stop instruction is appropriately transmitted from the control center 200 in order for operation management in the parking facility. If the stop instruction has not been received, the process returns to Step 405, and the vehicle 100 moves along the travel route 310 in the parking facility while repeating the processing up to Step 407.

If the vehicle 100 has received the stop instruction from the control center 200 in Step 407, the process proceeds to Step 408. In Step 408, it is determined whether the current position of the vehicle 100 is the null point. Specifically, it is determined whether the current position indicated by the host vehicle position estimation unit 104 corresponds to the null point received from the control center 200 and stored in the null point determination unit 107. If the current position is not the null point, the process proceeds to Step 409 and the vehicle 100 stops at the current position, that is, the stopping position. Then, the process returns to Step 403 and the vehicle 100 stands by until receiving a start instruction from the control center 200.

If it is determined in Step 408 that the current position of the vehicle 100 is the null point, the process proceeds to Step 410. In Step 410, the vehicle 100 moves at the slowest speed to an area where the reception signal intensity becomes equal to or greater than the threshold while confirming the reception signal intensity detected by the RSSI detection unit 115. That is, the vehicle 100 moves forward or backward until escaping the null point. As a result, it is possible to avoid a situation where the vehicle 100 stops at the null point, it becomes difficult to perform the wireless communication thereafter, and the vehicle 100 stays on the travel route 310.

When the vehicle 100 has escaped the null point, the process proceeds to Step 411. In Step 411, the vehicle 100 stops and transmits information indicating the stopping position to the control center 200. Then, the process returns to Step 403 and the vehicle 100 stands by until receiving a start instruction from the control center 200.

If it is determined in Step 406 that the vehicle 100 has reached the site before the parking position, the process proceeds to Step 412. In Step 412, the vehicle 100 parks at the parking position by automatic driving, and detects whether the reception signal intensity at this parking position is less than the threshold. If the reception signal intensity is less than the threshold, the process proceeds to Step 413. In Step 413, the vehicle 100 exits the parking position and moves until the vehicle 100 has escaped the null point. Then, the vehicle 100 moves, at the slowest speed, to the area where the reception signal intensity is equal to or greater than the threshold and stops, and transmits a parking position change request to the control center 200. As a result, it is possible to avoid a situation where the vehicle 100 is parked at the null point, it is difficult to perform the wireless communication thereafter, and it becomes difficult to cause the vehicle 100 to exit the parking spot.

After the process of Step 413, the vehicle 100 returns to the process of Step 402 and receives information such as a new parking position from the control center 200.

When the vehicle 100 is parked at the parking position by automatic driving and the reception signal intensity is equal to or greater than the threshold in Step 412, the process proceeds to Step 414. In Step 414, the vehicle 100 transmits the parking position information and the reception signal intensity to the control center 200. In the subsequent Step 415, the vehicle 100 stops a power source such as the engine.

FIG. 5 is a flowchart illustrating an operation of the vehicle when detecting an obstacle. FIG. 4 illustrates a detailed processing operation when the obstacle is detected on the travel route 310 in the parking facility in the processing illustrated in Step 405 of FIG. 4.

When the vehicle 100 detects an obstacle by the various external-environment sensors 101 during the traveling along the travel route 310 and the obstacle is removed, the various external-environment sensors 101 recognize that the obstacle has disappeared, and the traveling is started again. However, if the obstacle is not removed even after a lapse of a certain period of time, the processing operation illustrated in FIG. 5 is started. Incidentally, this corresponds to a case where a road cone or the like is placed on the travel route 310 intentionally or unintentionally, for example, as such an obstacle.

If the obstacle is not removed even after the lapse of the certain period of time, it is determined whether the stopping position of the vehicle 100 is the null point in Step 415 in FIG. 5. Specifically, it is determined whether the current position indicated by the host vehicle position estimation unit 104 corresponds to the null point received from the control center 200 and stored in the null point determination unit 107. If the stopping position is the null point, the process proceeds to Step 425, and the vehicle 100 gradually moves forward or backward to a position where the obstacle can be avoided independently of a command from the control center 200.

In the subsequent Step 435, the vehicle 100 confirms the reception signal intensity using the RSSI detection unit 115 to determine whether the vehicle 100 has moved to the area where the reception signal intensity is equal to or greater than the threshold, that is, whether the vehicle 100 has escaped the null point. If the vehicle 100 has not escaped the null point, the process returns to Step 425, and the vehicle 100 gradually moves to a position where the obstacle can be avoided.

If it is determined in Step 435 that the vehicle 100 has escaped the null point, the process proceeds to Step 445, and the vehicle 100 stops in Step 445. As a result, it is possible to avoid a situation where the vehicle 100 stops at the null point, it becomes difficult to perform the wireless communication thereafter, and the vehicle 100 stays on the travel route.

Then, the vehicle 100 notifies the control center 200 of that movement is not possible due to the obstacle in the subsequent Step 455. Incidentally, the control center 200 having received the notification takes measures such as dispatching a staff and re-searching a travel route that avoids the obstacle.

Incidentally, FIGS. 4 and 5 illustrate the operation at the time of entry of the vehicle 100, the same operation is performed even at the time of exit of the vehicle 100. That is, at the time of exit, the vehicle 100 is caused to automatically travel from a parking position to a carriage porch position. In this case, control is performed such that the vehicle 100 moves until escaping the null point by the same processing as described in Steps 401 to 411 of FIG. 4 and Steps 415 to 455 of FIG. 5.

According to the present embodiment, when there is the stop instruction from the control center or the obstacle is present on the route during the automated valet parking, the vehicle does not stop near the null point, and thus, it is possible to reliably receive a subsequent start instruction from the control center, and the vehicle can be prevented from staying on the travel route in the parking facility.

According to the above-described embodiment, the following operational effects are obtained.

(1) The vehicle control device includes: the wireless communication unit 105 that acquires the null point indicating the position at which wireless communication is poor in the parking facility 301 and the instruction information for controlling the vehicle 100 in the parking facility 301 from the control center 200 by means of wireless communication; and the automatic driving control unit 103 that moves the vehicle 100 until the vehicle 100 has escaped the null point and then stops the vehicle 100 when the instruction information acquired by the wireless communication unit 105 is the instruction for stopping the vehicle 100 and the instructed stopping position is the null point. As a result, it is possible to prevent the vehicle 100 from stopping at the null point even when the parking facility 301 is not spacious.

(2) The vehicle control device includes the null point determination unit 107 that determines the escaping the null point based on whether the reception signal intensity received from the control center 200 is equal to or greater than the threshold.

As a result, it is possible to detect that the vehicle 100 has escaped the null point and to avoid the stop of the vehicle 100 at the null point.

(3) The automatic driving control unit 103 changes the parking position to a new parking position when the instruction information acquired by the wireless communication unit 105 is the instruction to park the vehicle 100 and the parking position is the position less than the reception signal intensity. As a result, it is possible to avoid the parking of the vehicle 100 at the null point.

(4) The vehicle control device further includes the various external-environment sensors 101 that detect an obstacle of the vehicle, and the automatic driving control unit 103 moves the vehicle 100 until the vehicle 100 has escaped the null point while avoiding the obstacle and then stops the vehicle 100 when the obstacle does not move after the various external-environment sensors 101 detect the obstacle and the vehicle 100 stops at the null point. As a result, it is possible to prevent the vehicle 100 from stopping at the null point even when the obstacle is present.

(5) An automatic parking system includes the vehicle 100 and the control center 200 that performs wireless communication with the vehicle 100. The vehicle 100 detects the reception signal intensity received from the control center 200 and transmits the reception signal intensity to the control center 200. The control center 200 accumulates the reception signal intensity and the arrangement information of the vehicles parked in the parking facility 301, and stores the null point determined based on the reception signal intensity and the arrangement information of the parked vehicles in the null point storage unit 202. As a result, the control center 200 can update the null point according to the reception signal intensity and the arrangement information of the parked vehicles.

The present invention is not limited to the above-described embodiments, and other modes, which are conceivable inside a scope of a technical idea of the present invention, are also included in a scope of the present invention as long as characteristics of the present invention are not impaired.

### REFERENCE SIGNS LIST

100 vehicle
101 various external-environment sensors
102 various actuators
103 automatic driving control unit
104 host vehicle position estimation unit
105 wireless communication unit
107 null point determination unit
200 control center
201 map information storage unit
202 null point storage unit
203 management control unit
204 wireless communication unit

1. A vehicle control device comprising:
a wireless communication unit that acquires a null point indicating a position at which wireless communication is poor in a parking facility and instruction information for controlling a vehicle in the parking facility from a control center by means of wireless communication; and
a control unit that moves the vehicle until the vehicle has escaped the null point and then stops the vehicle when the instruction information acquired by the wireless communication unit is an instruction for stopping the vehicle and an instructed stopping position is the null point.

2. The vehicle control device according to claim 1, further comprising a null point determination unit that determines the escaping the null point based on whether a reception signal intensity received from the control center is equal to or greater than a threshold.

3. The vehicle control device according to claim 2, wherein the control unit changes the parking position to a new parking position when the instruction information acquired by the wireless communication unit is an instruction for parking the vehicle, and the parking position is a position less than the reception signal intensity.

4. The vehicle control device according to claim 2, further comprising a detection unit that detects an obstacle of the vehicle,
wherein the control unit moves the vehicle until the vehicle has escaped the null point while avoiding the obstacle and then stops the vehicle when the obstacle does not move after the detection unit detects the obstacle and the vehicle stops at the null point.

5. An automatic parking system comprising:
the vehicle control device according to claim 1; and
a control center that performs wireless communication with the vehicle control device.

6. The automatic parking system according to claim 5, wherein
the vehicle control device detects a reception signal intensity received from the control center, and transmits the reception signal intensity to the control center, and
the control center accumulates the reception signal intensity and arrangement information of parked vehicles in a parking facility, and stores the null point determined based on the reception signal intensity and the arrangement information of the parked vehicles.
